(19) United States
(12) Patent Application Publication
(10) Pub. No.: US 2009/0089820 A1
(43) Pub. Date: Apr. 2, 2009

(54) OPTICAL DISC APPARATUS

(75) Inventors: Takamasa Kurafuji, Higashikurume-shi (JP); Atsushi Osada, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/195,731

(22) Filed: Aug. 21, 2008

(30) Foreign Application Priority Data
Sep. 27, 2007 (JP) 2007-251698

(51) Int. Cl. G11B 7/08

(52) U.S. Cl. 720/689

(57) ABSTRACT

According to one embodiment, an optical disc apparatus includes a main frame, a medium drive unit, and an ascent/descent retaining member which supports the medium drive unit for ascent and descent. The ascent/descent retaining member includes a pair of arm portions, a connecting portion, and pivotal portions supported on the sidewalls, individually. One of the front wall of the main frame and the connecting portion integrally has a guide boss projecting toward the other of them and a press projection which is elastically deformable in a direction in which the connecting portion extends. The other of the front wall and the connecting portion has a guide groove which extends in the ascent and descent direction and is engaged with the guide boss, and a guide rib having a guide surface for deforming the press projection to generate an elastic force and provided adjacent to the guide groove.

### CROSS-REFERENCE TO RELATED APPLICATIONS

This application is based upon and claims the benefit of priority from Japanese Patent Application No. 2007-251698, filed Sep. 27, 2007, the entire contents of which are incorporated herein by reference.

### BACKGROUND

1. Field

One embodiment of the present invention relates to an optical disc apparatus for performing information processing to a disc shaped recording medium.

2. Description of the Related Art

In recent years, optical discs have been widespread for use as disc recording media, including the read-only type represented by a DVD-ROM, the one-time recording type represented by a DVD-R, and the rewritable type represented by a DVD-RAM and DVD-RW that can be utilized for externally attached memories for computers, recording and playback video systems, etc.

Optical disc apparatuses for recording and reproducing information to and from the optical disc have a housing including a disc insertion port and a disc tray for supporting the optical disc and loading and unloading the optical disc on and from the housing. The disc tray is movable between a drawn-out position in which the disc can be loaded and unloaded and a drive position in which the disc that is drawn into the housing can be driven.

The housing contains therein a motor that supports and rotates the loaded optical disc, an optical pickup that reads and writes information from and to the disc, etc. The motor and the pickup are provided on a pickup chassis, which is placed on a chassis mount that is arranged for rotation in the housing.

As the disc tray moves, the pickup chassis, along with the chassis mount, is retracted to a lowered position. When the optical disc is drawn into a predetermined drive position, the pickup chassis and the chassis mount are rocked upward. Thereupon, the motor ascends and clamps the disc, and the optical pickup faces a recording surface of the optical disc.

In the optical disc apparatus, when an optical disc rotates at a high speed, vibration is produced due to eccentricity, mass eccentricity, and the like of the optical disc. Accordingly, when a mechanical system has a rattle, the pick-up chassis, the chassis mount, and the like are vibrated, which adversely affects the recording and reproducing operation of the optical disc. Further, a strange noise may be produced when mechanical components collide with each other repeatedly.

Jpn. Pat. Appln. KOKAI Publication No. 10-21680 discloses an optical disc apparatus for absorbing vibration and reducing noise by interposing a plate spring between a housing and a chassis mount and eliminating rattle and play by urging the chassis mount in one direction by the plate spring.

However, when an urging member such as a plate spring is added to reduce the rattle of components as in the optical disc apparatus described above, manufacturing cost is increased by an increase of the number of components and assembly processes. Further, the increase in the number of components requires an installation space corresponding thereto, which prevents the apparatus from becoming compact. Further, when the rattle is physically eliminated, since a rattle is produced by the contraction/expansion of components caused by a change of temperature or components are meshed with each other and overloaded, the operation of the apparatus may be prevented thereby.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an optical disc apparatus, from which a top cover is removed, according to an embodiment of the invention;

FIG. 2 is an exemplary perspective view showing an internal structure of the optical disc apparatus in the state that the disc tray is removed;

FIG. 3 is an exemplary perspective view showing the optical disc apparatus from which a disc drive unit is removed;

FIG. 4 is an exemplary enlarged perspective view showing a portion in which a chassis mount is engaged with a main frame;

FIG. 5 is an exemplary perspective view showing the main frame;

FIG. 6 is an exemplary enlarged perspective view showing the portion of a guide groove and a guide surface which are formed to the main frame;

FIG. 7 is an exemplary front view showing the guide groove and the guide surface;

FIG. 8 is an exemplary perspective view showing the back surface side of the disc tray of the optical disc apparatus and the chassis mount;

FIG. 9A is an exemplary sectional view of the optical disc apparatus showing a state in which the disc tray is drawn to an operating position;

FIG. 9B is an exemplary sectional view of the optical disc apparatus showing a state in which the disc tray is drawn out to a loading/unloading position;

FIG. 10 is an exemplary exploded perspective view showing the disc drive unit, a movement mechanism, and the chassis mount;

FIG. 11 is an exemplary perspective view showing the chassis mount of the optical disc apparatus;

FIG. 12 is an exemplary enlarged perspective view showing the portion of a guide boss and a press projection of the chassis mount;

FIG. 13 is an exemplary enlarged front view showing the portion of the guide boss and the press projection of the chassis mount;

FIG. 14 is an exemplary perspective view showing the chassis mount and a cam slider of the optical disc apparatus;

FIG. 15 is an exemplary front view showing the cam slider;

FIG. 16 is an exemplary perspective view showing the cam slider and the chassis mount at a first position and a raised position;

FIG. 17 is an exemplary sectional view showing the cam slider and the chassis mount at the first position and the raised position;

FIG. 18 is an exemplary front view showing how the guide boss and the press projection are engaged with the guide groove and the guide surface at the raised position;

FIG. 19 is an exemplary perspective view showing the cam slider and the chassis mount at a second position and a lowered position;

FIG. 20 is an exemplary sectional view showing the cam slider and the chassis mount at the second position and the lowered position;

FIG. 21 is an exemplary front view showing how the guide boss and the press projection are engaged with the guide groove and the guide surface at the lowered position;

FIG. 22 is an exemplary side view showing the optical disc apparatus in a state in which it is subjected to a drop shock;

FIG. 23 is an exemplary enlarged side view showing the portion in which the chassis mount is engaged with the main frame in FIG. 22;

FIG. 24 is an exemplary enlarged perspective view showing the portion in which a the chassis mount is engaged with a main frame in an optical disc apparatus according to another embodiment of the invention;

FIG. 25 is an exemplary enlarged perspective view showing the portion of a guide groove and a guide surface formed to the chassis mount; and

FIG. 26 is an exemplary enlarged perspective view showing a part of the main frame.

### DETAILED DESCRIPTION

Various embodiments according to the invention will be described hereinafter with reference to the accompanying drawings. In general, according to one embodiment of the invention, there is provided an optical disc apparatus comprising: a main frame having a pair of opposing sidewalls and a front wall extending between the sidewalls; a medium drive unit including a motor which is configured to support and rotate the recording medium and a head unit configured to process information on the recording medium, and arranged for ascent and descent between a drive position in which the recording medium is driven and a retracted position in which the recording medium is allowed to be loaded and unloaded; and an ascent/descent retaining member which supports the medium drive unit and is supported by the main frame for ascent and descent between a raised position corresponding to the drive position and a lowered position corresponding to the retracted position; the ascent/descent retaining member including a pair of arm portions extending opposite the sidewalls, individually, a connecting portion extending between one ends of the arm portions and opposing the front wall, and pivotal portions arranged on the respective other end portions of the arm portions and supported on the sidewalls, individually, one of the front wall of the main frame and the connecting portion of the ascent/descent retaining member integrally having a guide boss projecting toward the other of them and a press projection which is provided adjacent to the guide boss and formed to be elastically deformable in a direction in which the connecting portion extends, and the other of the front wall and the connecting portion having a guide groove which extends in the ascent and descent direction and is engaged with the guide boss, and a guide rib which has a guide surface for deforming the press projection to generate an elastic force and is provided adjacent to the guide groove.

An optical disc apparatus according to an embodiment of the invention will be explained in detail referring to the drawings.

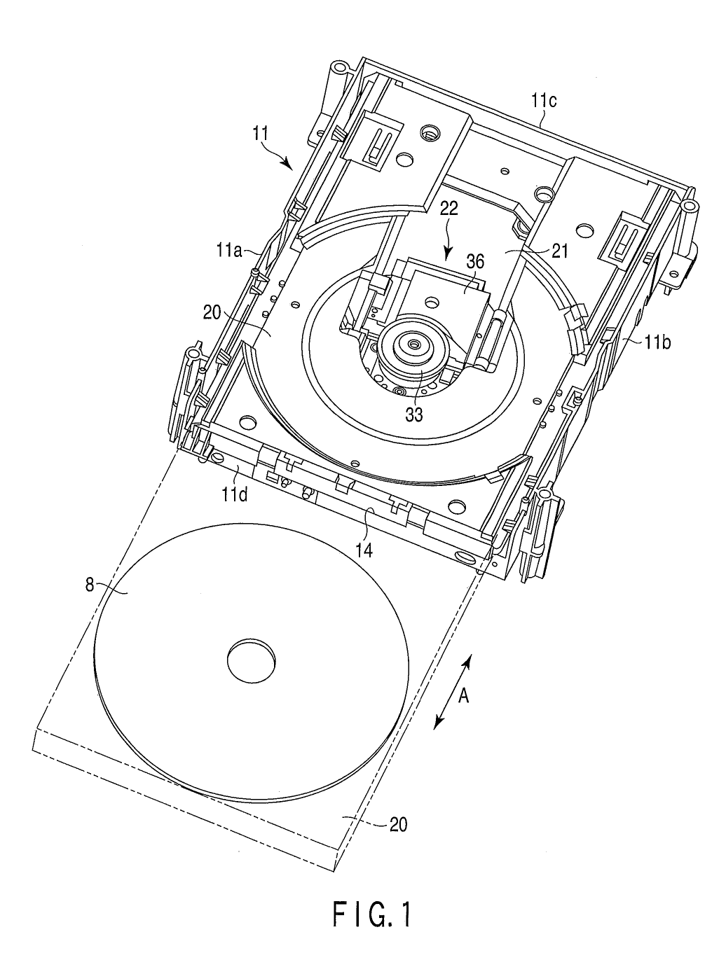

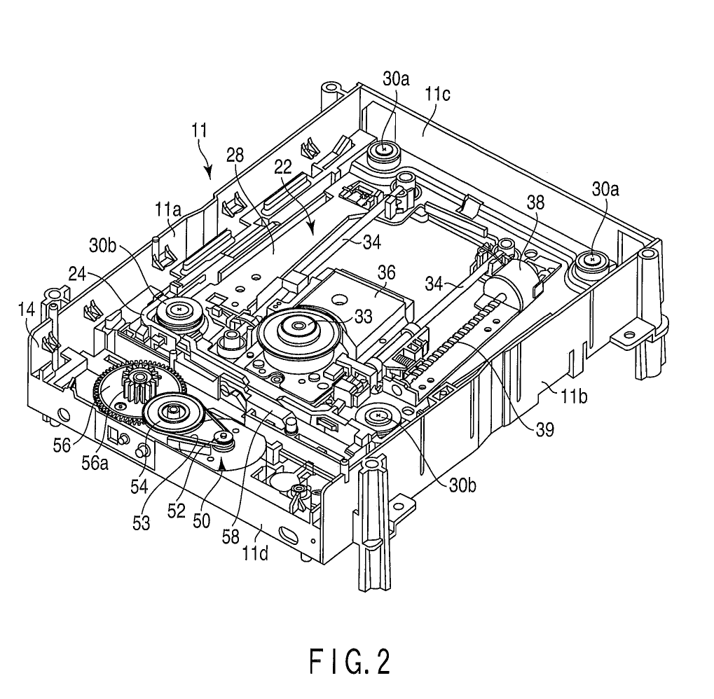

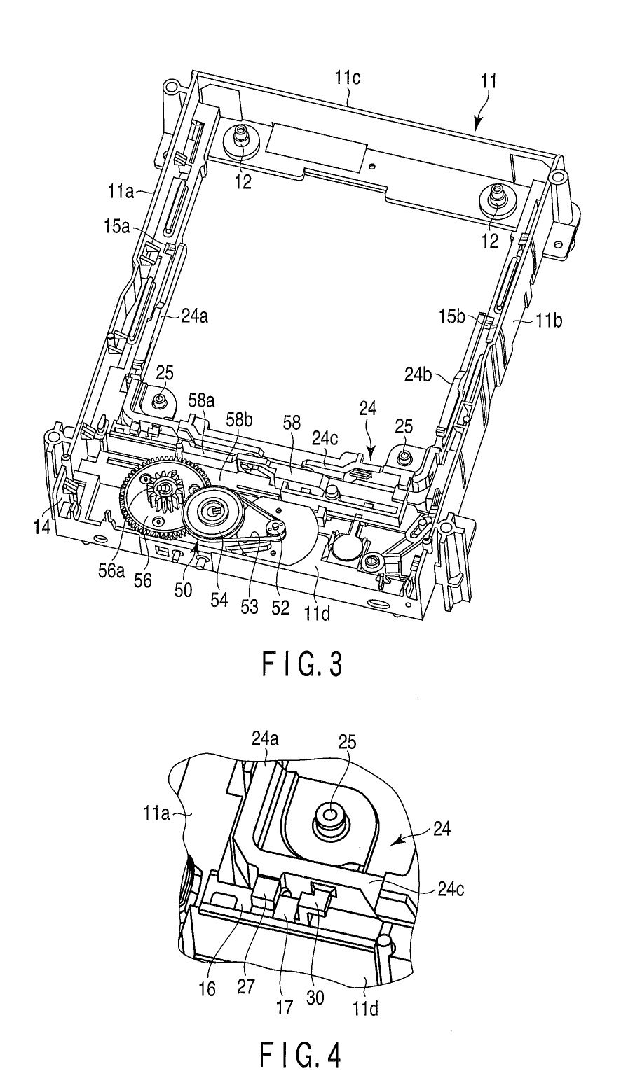

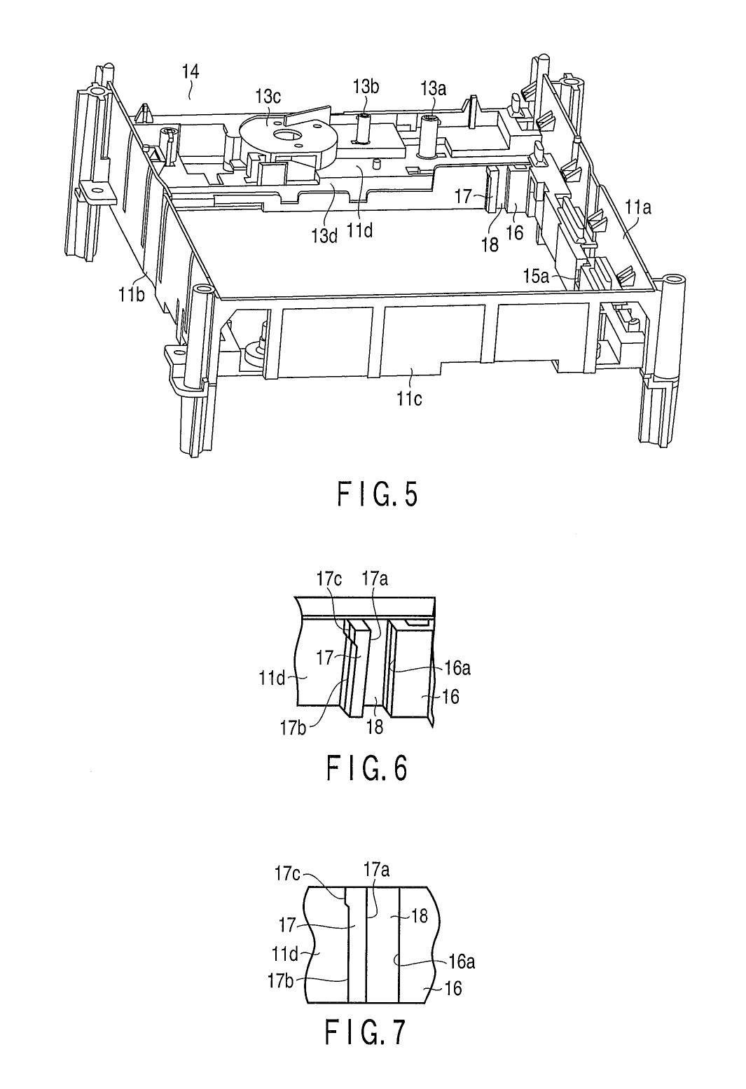

FIG. 1 shows a structure of the optical disc apparatus according to the embodiment when it is viewed from outside by removing a top cover therefrom, and FIG. 2 shows an internal structure of the optical disc apparatus by omitting a disc tray to be described later. FIGS. 3 and 5 show a main frame of the optical disc apparatus.

As shown in FIGS. 1 and 2, the optical disc apparatus has a rectangular box-shaped main frame 11 with an open upper surface for constituting a housing. The main frame 11 has a disc tray 20 for holding and transporting an optical disc 8 as a recording medium, a disc drive unit 22 which is free to rise and fall and supports and rotates the optical disc 8, and a movement mechanism 50 for moving the disc tray 20 and the disc drive unit 22 each disposed therein. A not shown circuit board constituting a controller is mounted on the bottom surface of the main frame 11.

As shown in FIGS. 2, 3, and 5, the main frame 11 has a pair of sidewalls 11a, 11b, which oppose parallel to each other with an interval, and a back wall 11c and a front wall 11d each extending between these sidewalls 11a, 11b integrally therewith, and these walls are form of a synthetic resin such as ABS and the like. Engaging recesses 15a, 15b are formed on the respective inner surface sides of the pair of sidewalls 11a, 11b to pivotably support the fulcrum of a chassis mount 24 to be described later. A pair of support posts 12 are disposed at two corners located inside of the back wall 11c of the main frame 11 to support the disc drive unit 22.

The front wall 11d extends between the front end of the sidewalls 11a, 11b and opposes with the back wall 11c approximately in parallel therewith. The front wall 11d has a disc insertion port 14 formed of a rectangular opening. Further, the front wall 11d constitutes a mounting portion for mounting the movement mechanism 50. That is, a gear fulcrum boss 13a, a pulley gear fulcrum boss 13b, a motor mounting portion 13c, and a slide groove 13d for movably supporting a cam slider to be described later are formed to the front wall 11d.

As shown in FIGS. 5, 6, and 7, first and second guide ribs 16, 17 project from an end of the inner surface of the front wall 11d opposing the back wall 11c, for example, from the end thereof on the sidewall 11a side. The first and second guide ribs 16, 17 extend in a direction orthogonal to the direction in which the front wall 11d extends, here, in a vertical direction. The first and second guide ribs 16, 17 are disposed side by side at an interval in the direction in which the front wall 11d extends. The side surface 16a of the first guide rib 16 opposes to the side surface 17a of the second guide rib 17, a guide groove 18 is defined therebetween. The guide groove 18 extends in the rising/falling direction of the chassis mount 24 and the width of the guide groove is gradually narrowed from the lowered position of the chassis mount to be described later to the raised position thereof, here, from downward to upward.

The opposite side surface of the second guide rib 17 constitutes a guide surface 17b extending in the rising/falling direction of the chassis mount 24. A projection 17c projecting in a direction opposite to the guide groove 18 is formed to the upper end of the guide surface 17b.

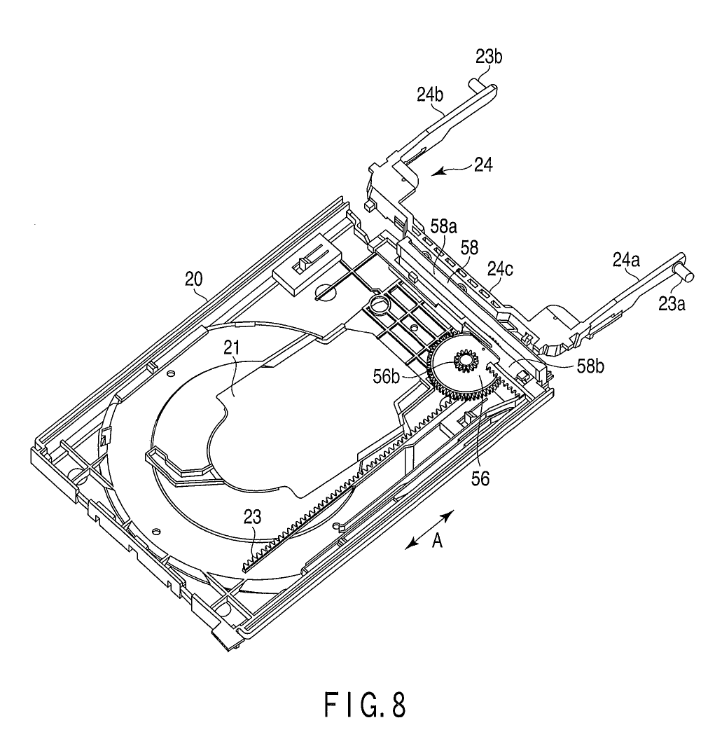

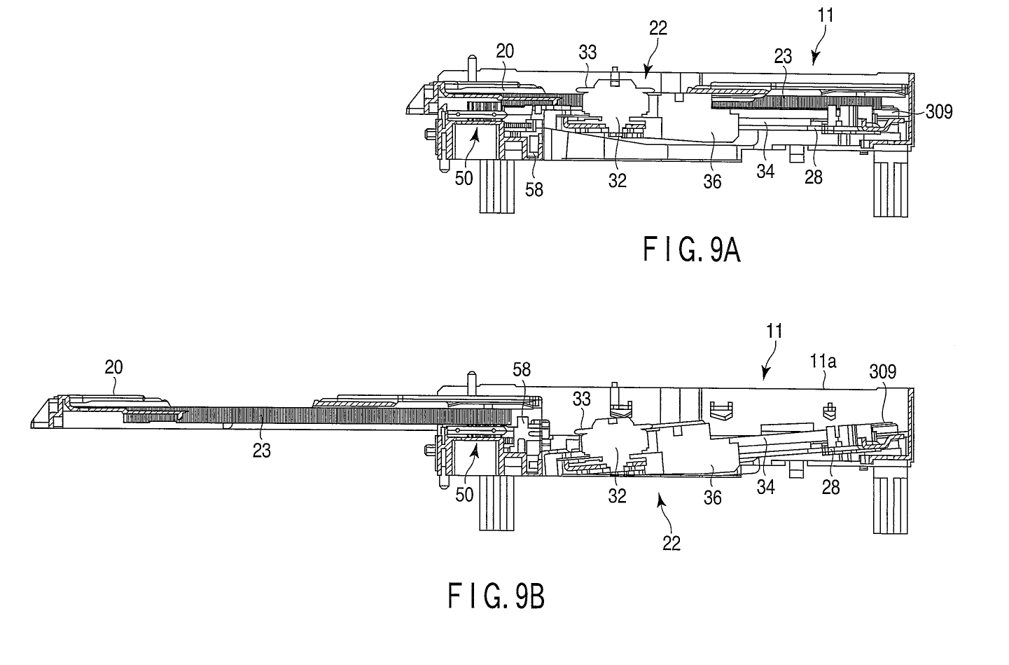

FIG. 8 shows the back surface side of the disc tray 20 acting as a recording medium holder and how the movement mechanism 50 is engaged with the disc tray 20. FIG. 9A is a sectional view of the optical disc apparatus showing a state in which the disc tray is drawn to an operating position, and FIG. 9B is a sectional view of the optical disc apparatus showing a state in which the disc tray is moved to a loading/unloading position.

As shown in FIGS. 1 and 8, the disc tray 20 is formed in an approximately rectangular plate shape, and a window 21 is formed in a part thereof to allow the disc drive unit 22 to access the optical disc 8. The disc tray 20 is arranged between the sidewalls 11a, 11b and supported to be movable in a direction parallel to the sidewalls, that is, in the longitudinal direction (moving direction A) of the main frame 11. A rack 23 is formed on the back surface of the disc tray 20 and extends approximately the entire length of the disc tray in the longitudinal direction. The rack 23 is meshed with a tray gear 56a of the movement mechanism 50 to be described later.

The disc tray 20 is supported such that it can linearly move between the operating position, which is shown by a solid line in FIGS. 9A and 1, that is, a predetermined position in the main frame 11 to which the disc tray 20 is drawn, and the loading/unloading position, which is shown by a two-dot-and-dashed-line in FIGS. 9B and 1 and projects to the outside of the main frame 11 through the disc insertion port 14 and is moved between the operating position and the loading/unloading position by the movement mechanism 50. The optical disc 8 held by the disc tray 20 can be driven by the disc drive unit 22 at the operating position, and the optical disc 8 can be mounted on and dismounted from the disc tray 20 at the loading/unloading position.

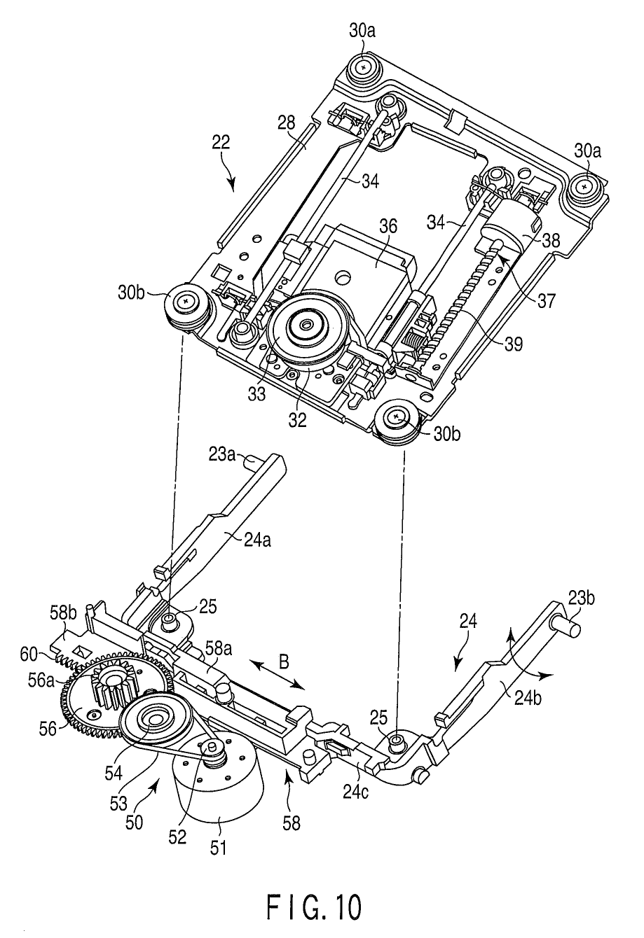

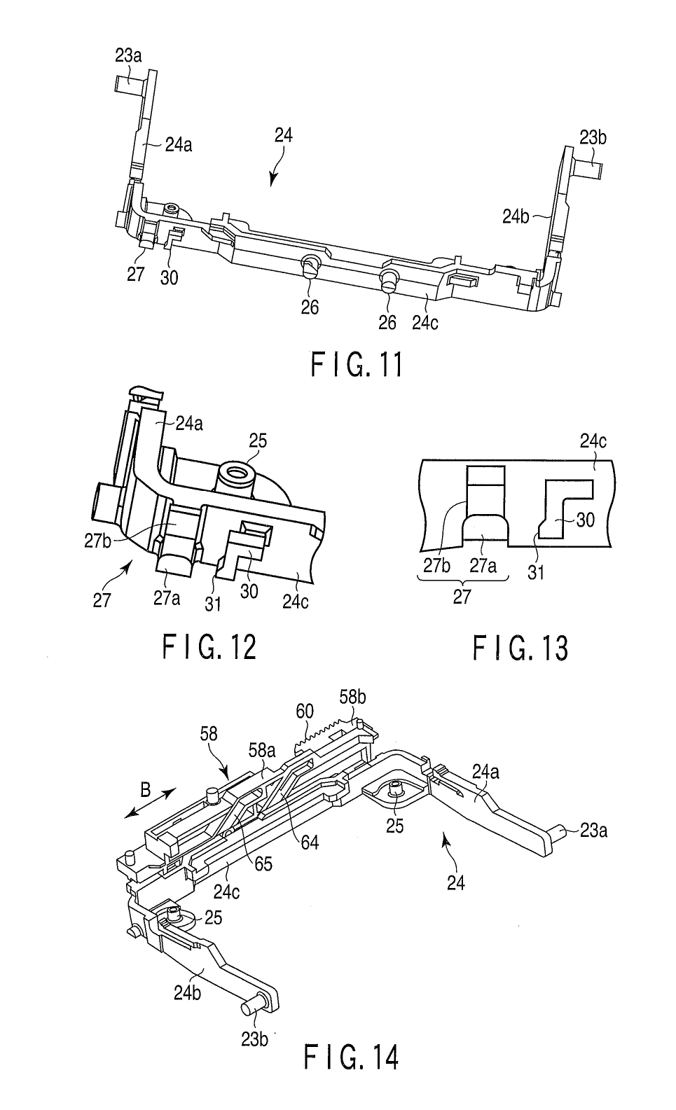

FIG. 10 is an exploded perspective view showing the disc drive unit 22, the movement mechanism 50, and the chassis mount 24 of the optical disc apparatus, FIG. 11 shows the chassis mount, and FIGS. 12 and 13 show the portion of the guide boss and the press projection of the chassis mount in enlargement.

As shown in FIGS. 3, 10, and 11, the chassis mount 24 is provided at the main frame 11 to support the disc drive unit 22 for up-and-down motion. The chassis mount 24 is formed in an substantially U-shape and pivotably attached to the main frame 11. The chassis mount 24 acting as an ascent/descent retaining member has a pair of arm portions 24a, 24b opposing parallel to each other at an interval, and a connecting portion 24c which extends between one ends of the arm portions 24a, 24b orthogonal thereto and couples the distal ends of the arm portions 24a, 24b with each other.

Pivots 23a, 23b acting as pivoting fulcrums are formed at the rear ends of the arm portions 24a, 24b, respectively and project to the outside from the arm portions. A pair of support posts 25 are disposed to the inside of the respective corners of the chassis mount 24 to support the disc drive unit 22. The chassis mount 24 has a pair of engaging pins 26 to be engaged with a slide cam of the movement mechanism 50 to be described later. These engaging pins 26 project forward from the connecting portion 24c in a central portion thereof and are located away from each other in the extending direction of the connecting portion 24c.

As shown in FIGS. 11 to 13, the chassis mount 24 has a guide boss 27 and a press projection 30 formed to the connecting portion 24c integrally therewith. The guide boss 27 is provided at one end of the connecting portion 24c, for example, to the end thereof on the arm portion 24a side and projects forward, that is, toward the front wall 11d of the main frame 11. The guide boss 27 includes a guide portion 27a having a predetermined width, and a reinforcing portion 27b having a width narrower than the guide portion for reinforcing the guide portion 27a integrally therewith. With this arrangement, the guide boss 27 has such a sufficient strength that it is not broken even if it receives a drop shock load.

The press projection 30 is arranged at an interval to the guide boss 27 in the extending direction of the connecting portion 24c. After the press projection 30 extends from the connecting portion 24c toward the front wall 11d, it is bent at right angles, and extends downward. An abutting portion 31 projecting to the guide boss 27 side is formed to the extending end of the press projection 30. With this arrangement, the press projection 30 is formed such that it can be elastically deformed in the extending direction of the connecting portion 24c and produces an elastic force in the above direction when flexed.

The chassis mount 24 including the guide boss 27, the press projection 30, and the engaging pins 26 are integrally molded of, for example, a resin harder than the main frame 11.

As shown in FIG. 3, the chassis mount 24 is attached to the main frame in the state that the pivots 23a, 23b are pivotably engaged with the engaging recesses 15a, 15b formed to the sidewalls 11a, 11b of the main frame 11, respectively. The pair of arm portions 24a, 24b extend parallel to the sidewalls 11a, 11b, respectively. The connecting portion 24c is located on the disc insertion port 14 side with respect to the pivots 23a, 23b and extends between the sidewalls 11a, 11b in a direction orthogonal to the sidewalls as well as opposing the front wall 11d of the main frame 11 at an interval. The chassis mount 24 is supported about the pivots 23a, 23b so that it can be pivoted between the raised position and the lowered position, and the connecting portion 24c is raised and fallen as the chassis mount 24 is pivoted between the raised position and the lowered position.

As shown in FIGS. 3 and 4, the guide boss 27 formed to the connecting portion 24c is engaged with the guide groove 18 formed to the front wall 11d, and the press projection 30 is located in opposition with the guide surface 17b of the second guide 17 formed to the front wall 11d. The second guide rib 17 is located in the state that it is clamped between the guide boss 27 and the press projection 30. As the connecting portion 24c rises and falls, the guide boss 27 moves in the guide groove 18, and the press projection 30 moves along the guide surface 17b.

As shown in FIGS. 2 and 10, the disc drive unit 22 has a rectangular frame-shaped chassis 28 formed of a metal sheet. A spindle motor 32 as a drive source is mounted on the front end of the chassis 28 in the longitudinal direction thereof, and a turntable 33, which supports the optical disc 8 and rotates it at a predetermined speed, is fixed to a rotating shaft of the spindle motor 32. A pair of guide rails 34 extending parallel to each other are attached to the chassis 28. The guide rails 34 extend while being slightly inclined with respect to the sidewalls 11a, 11b of the main frame 11.

The disc drive unit 22 has an optical pick-up 36 for writing and reading information to and from the optical disc 8 and a pick-up drive mechanism 37 for moving the optical pick-up 36. The optical pick-up 36 is supported by the pair of guide rails 34 so that it can reciprocatingly move along the guide rails 34. The pick-up drive mechanism 37 has a feed motor 38 mounted on the chassis 28 and a lead screw 39 coupled with a rotating shaft of the feed motor 38. The lead screw 39 extends parallel to the guide rails 34 as well as being engaged with the optical pick-up 36.

The optical pick-up 36 acting as a head unit is located in opposition with an information recording surface of the optical disc 8 supported on the turntable 33 when information is read and written from and to the optical disc 8 and is moved in the diameter direction of the optical disc 8 along the guide rails 34 by the pick-up drive mechanism 37.

The two corners of the chassis 28 on one side (rear end side) in the longitudinal direction thereof are elastically supported by the support post 12 of the back wall 11c of the main frame 11 by a pair of first dampers 30a, and the other end side (front end side) of the chassis 28 in the longitudinal direction side thereof are supported by the support post 25 of the chassis mount 24 by a pair of second dampers 30b. With this arrangement, the chassis 28 is elastically supported by the four dampers 30a, 30b.

The disc drive unit 22 is supported such that it can be pivoted between the raised position (driving position) shown in FIG. 9A and the lowered position (retracted position) shown in FIG. 9B together with the chassis mount 24 using the pair of first dampers 30a as fulcrums, that is, it can rise and fall. The chassis 28 is located approximately parallel to the disc tray 20 at the driving position and located at the retracted position such that the end of the chassis 28 on the second dampers 30b side is located away from the disc tray 20 downward.

As shown in FIGS. 2, 3, 5, 8, 10, and 14, the movement mechanism 50 for moving the disc tray 20 and the disc drive unit 22 is provided at the front wall 11d of the main frame 11 and located below the disc tray 20. The movement mechanism 50 has a loading motor 51 as a drive source mounted on the motor mounting portion 13c of the front wall 11d, a pulley 52 inserted on a rotating shaft of the loading motor under pressure, a pulley gear 54 rotatably attached to the pulley gear fulcrum boss 13b of the front wall, a drive belt 53 stretched between the pulley 52 and the pulley gear 54, a drive gear 56 meshed with the pulley gear 54 rotatably attached to the gear fulcrum boss 13a of the front wall, and a cam slider 58.

The tray gear 56a, which is meshed with the rack 23 of the disc tray 20, is formed on one surface of the drive gear 56 coaxially therewith, and a cam gear 56b meshed with the rack of the cam slider 58 is formed on the other surface of the drive gear 56 coaxially therewith. A rotating shaft of the loading motor 51 and respective rotating shafts of the pulley 52, the pulley gear 54, and the drive gear 56 extend in a direction orthogonal to the surface of the disc tray 20.

The cam slider 58 acting as a sliding member has a slender plate-shaped cam plate 58a extending in the direction B orthogonal to the moving direction A of the disc tray 20 and a guide plate 58b extending forward from the cam plate, and they are integrally molded of a synthetic resin and the like. The cam slider 58 is supported by the main frame 11 in the state that the lower end of the cam plate 58a is engaged with the slide groove 13d (refer to FIG. 5) of the front wall 11d so as to slide in the direction B orthogonal to the moving direction A of the disc tray 20. The cam plate 58a is located in opposition with the connecting portion 24c of the chassis mount 24.

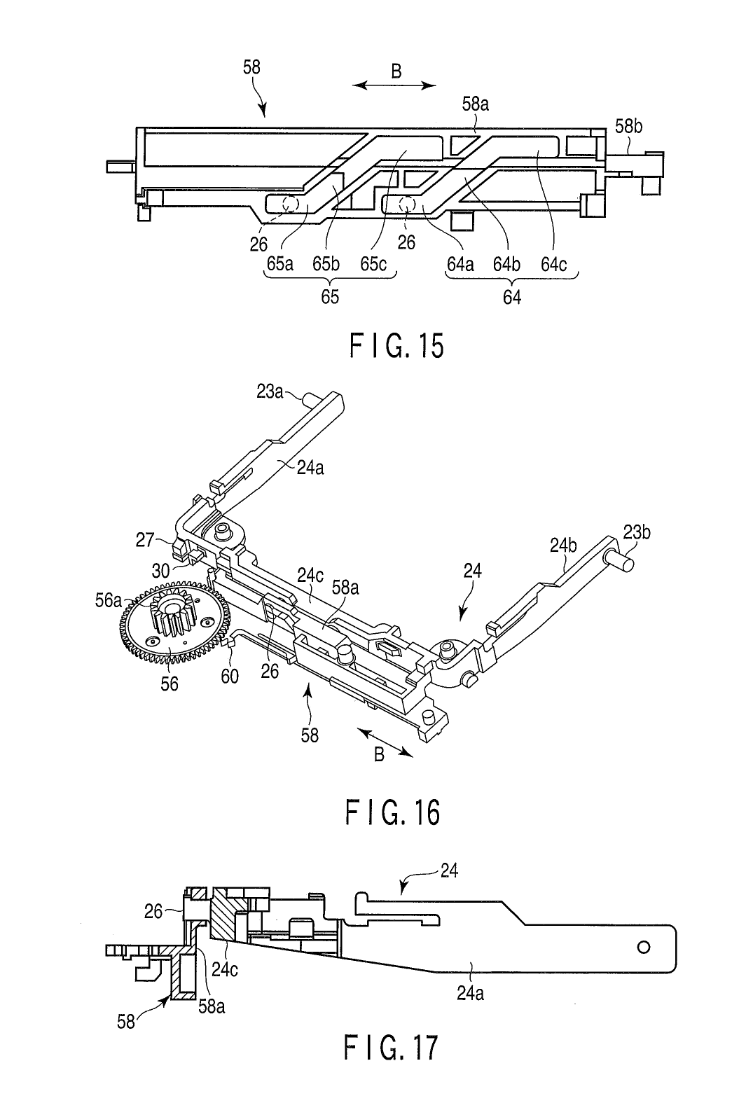

As shown in FIGS. 10, 14, 15, a rack 60, which can be meshed with the cam gear 56b, is formed to one end of the guide plate 58b. The cam slider 58 is driven by the cam gear 56b and reciprocatingly moved in the moving direction B in association with the movement of the disc tray 20. A pair of cam grooves 64, 65 are formed to the cam plate 58a. The pair of cam grooves 64, 65 are formed parallel to each other.

The respective cam grooves 64, 65 have first groove portions 64a, 65a extending horizontally in the moving direction B, inclined groove portions 64b, 65b extending obliquely upward from the first groove portions 64a, 65a, and second groove portions 64c, 65c extending horizontally in the moving direction B from the upper ends of the inclined groove portions 64b, 65b. In one cam groove 64, the second cam groove ends of the second groove portion 64c and the inclined groove portions 64b pass through the cam plate 58a and open on both the surfaces of the cam plate. The front surface sides of the other portion of the cam groove 64 and the cam groove 65 are covered with the cam plate 58a and formed as bottomed grooves.

The pair of engaging pins 26 projecting from the connecting portion 24c of the chassis mount 24 are slidably engaged with the pair of cam grooves 64, 65 of the cam plate 58a. As the cam slider 58 moves, the engaging pins 26 move in the cam grooves 64, 65, thereby the chassis mount 24 is risen and fallen.

When the loading motor 51 of the movement mechanism 50 is driven, driving power is transmitted from the pulley 52 to the pulley gear 54 through the drive belt 53 and to the drive gear 56, thereby the cam slider 58 is moved in the moving direction B. As the cam slider 58 moves, the engaging pins 26 of the chassis mount 24 move along the cam grooves 64, 65. The chassis mount 24 is pivoted using the pivots 23a, 23b as the fulcrums in association with the movement of the cam slider 58 to thereby perform a rising/falling operation. With this operation, the disc drive unit 22 is pivoted using the first dampers 30a as fulcrums and performs the rising/falling operation together with the chassis mount 24.

The disc tray 20 is driven by the tray gear 56a and moved in the moving direction A. While the disc tray 20 moves, the disc drive unit 22 is moved to the lowered position (retracted position) so that it does not prevent the movement of the disc tray 20.

In a waiting state or an operating state of the optical disc apparatus, the cam slider 58 is located at a first position and the engaging pins 26 of the chassis mount 24 are located in the second groove portions 64c, 65c of the cam grooves 64, 65 as shown in FIGS. 9A, 16, and 17. With this operation, the chassis mount 24 is held at the raised position, and the disc drive unit 22 is moved to the driving position (raised position).

When the optical disc 8 is mounted on or dismounted from the optical disc apparatus, the loading motor 51 is driven by depressing a not shown eject button provided on the front surface of the main frame 11 or in response to an external command for dismounting the optical disc. As a result, the cam slider 58 is moved from the first position shown in FIG. 16 toward a second position shown in FIGS. 10, 14, 19 in the B direction. The engaging pins 26 of the chassis mount 24 are moved from the second groove portions 64c, 65c to the first groove portion 64a, 65a in the cam grooves 64, 65 in association with the movement of the cam slider 58. With this operation, the chassis mount 24 moves from the raised position to the lowered position shown in FIGS. 9, 14, 19, 20, thereby the disc drive unit 22 is fallen from the driving position to the retracted position.

After the disc drive unit 22 is moved to the retracted position, the disc tray 20 is moved from the operating position shown by the solid line in FIG. 1 to the loading/unloading position shown by the two-dot-and-dash-line in FIGS. 9B and 1 by the loading motor 51 and extends to the outside from the main frame 11. In this state, the optical disc 8 can be mounted on and dismounted from the disc tray 20.

When a not shown loading switch is depressed or an external command for mounting an optical disc is input after the optical disc 8 is mounted on the disc tray 20, the loading motor 51 is driven inversely, thereby the disc tray 20 is moved from the loading/unloading position to the operating position by the movement mechanism 50. With this operation, the optical disc 8 is drawn into the main frame 11 together with the disc tray 20 and held at a predetermined position.

The cam slider 58 is moved from the second position toward the first position in the state that the disc tray 20 is moved to the operating position. The engaging pins 26 of the chassis mount 24 are moved from the first groove portions 64a, 65a to the second groove portions 64c, 65c through the inclined groove portions 64b, 65b in the cam grooves 64, 65 in association with the movement of the cam slider 58. With this operation, the chassis mount 24 moves from the lowered position to the rise position shown in FIGS. 16, 17, thereby the disc drive unit 22 rises from the retracted position to the driving position and is held at the driving position.

With this operation, the optical disc 8 placed on the disc tray 20 is clamped between the turntable 33 of the disc drive unit 22 and a disc clamp member provided on the inner surface of a not shown top cover and rotatably held therebetween. Further, the optical pick-up 36 is located in opposition with the recording surface of the optical disc 8. The turntable 33 and the optical disc 8 are rotated at a predetermined speed in this state by the spindle motor 32, and information is written or read to or from the optical disc 8 by the optical pick-up 36.

In contrast, while the chassis mount 24 described above is risen and fallen, the guide boss 27 formed to the connecting portion 24c moves in the guide groove 18 formed to the main frame 11, and the press projection 30 moves in opposition with the guide surface 17b of the guide rib 17 of the main frame.

As described above, the guide groove 18 is formed such that the width thereof is gradually narrowed from the lower end toward the upper end thereof. Further, the width of the guide boss 27 is formed slightly smaller than the width of the upper end of the guide groove 18, for example, about 0.05 mm to 0.1 mm to secure a smooth sliding operation. Accordingly, while the chassis mount 24 moves between the lowered position and just in front of the raised position, the guide boss 27 moves in the guide groove 18 with a gap so that the sliding load on the chassis mount 24 can be minimized. When the chassis mount 24 moves to the raised position, the guide boss 27 is regulated by the gap described above to the width refined by the side surfaces 16a, 17a of the first and second guide ribs 16, 17 defining the guide groove 18.

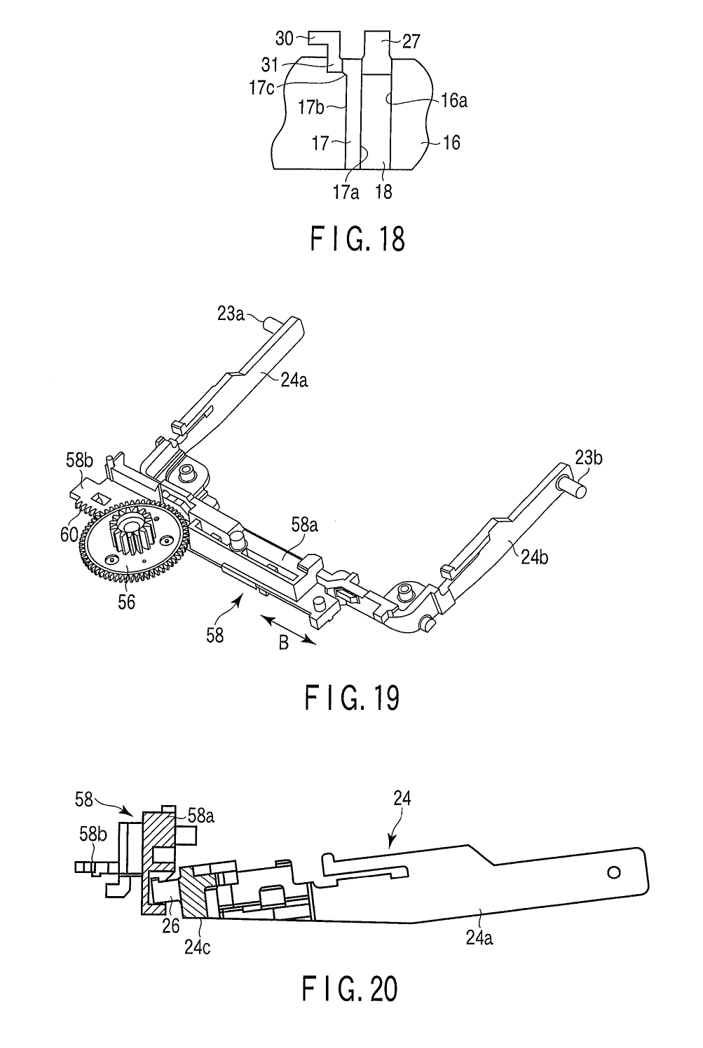

Further, while the chassis mount 24 moves between the lowered position and just in front of the raised position, the press projection 30 moves at an interval to the guide surface 17b so that the sliding load on the chassis mount 24 can be minimized. As shown in FIG. 18, when the chassis mount 24 moves to the raised position, the abutting portion 31 of the press projection 30 abuts the projecting portion 17c of the guide surface 17b and flexed a predetermined amount, for example, about 0.5 mm to thereby produce an elastic force. With this operation, the press projection 30 elastically presses the second guide rib 17 of the main frame 11 and clamps the second guide rib 17 between the press projection 30 and the guide boss 27. Accordingly, the guide boss 27 of the chassis mount 24 is elastically pressed to the side surface 17a of the second guide rib which defines the guide groove 18 and fixed. With this operation, the rattle of the chassis mount 24 and the disc drive unit 22, which have moved to the raised position, is suppressed so that the vibration produced by driving a disc having eccentricity or mass eccentricity can be suppressed, and production of noise can be also suppressed.

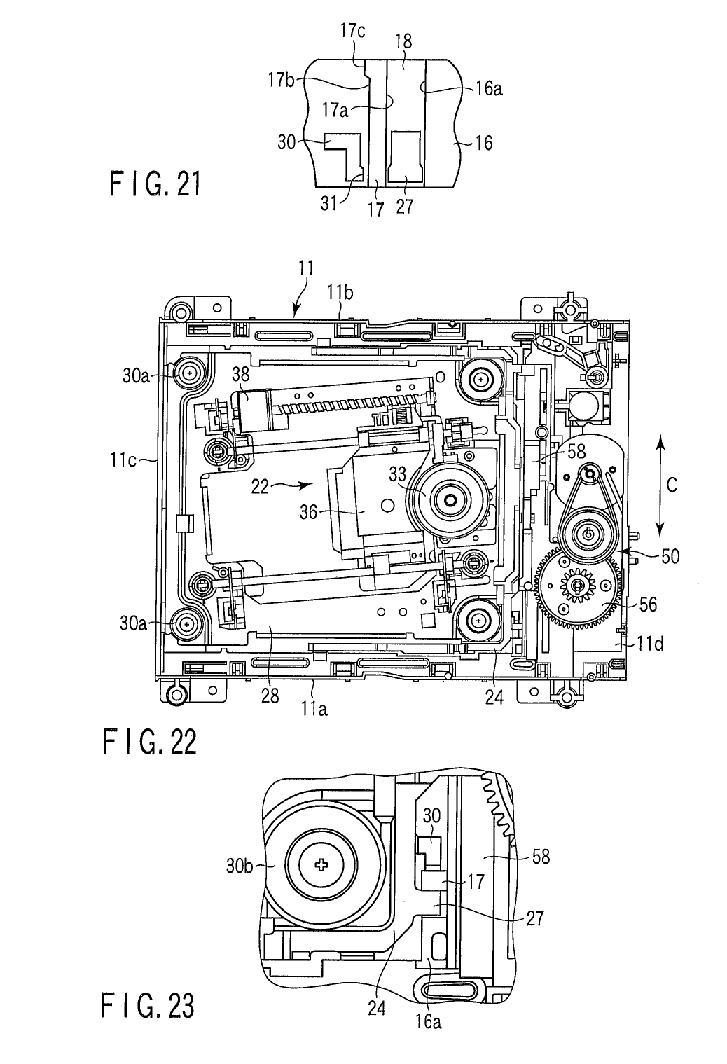

As shown in FIGS. 22 and 23, when, for example, the optical disc apparatus drops and receives a shock in a shock direction C, the apparatus receives a dropping shock force in such a manner that the guide boss 27 of the chassis mount 24 is received by the first and second guide ribs 16, 17 of the main frame 11. Accordingly, when the drop shock is produced, since a large amount of dropping shock force is not applied to the press projection 30, it is not damaged. Accordingly, the press projection 30 can be formed in an ideal shape for generating an elastic force for suppressing vibration to achieve the intrinsic function thereof.

According to the optical disc apparatus arranged as described above, the guide rib and the press projection are formed to the chassis mount integrally therewith, and the guide groove, which is engaged with the guide rib, and the guide surface, which abuts against the press projection and produces the elastic force, are disposed to the main frame. As a result, the chassis mount and the disc drive unit can be held without rattle, thereby it is possible to suppress vibration and noise which are produced when a disc, which ordinarily has eccentricity and mass eccentricity the magnitude of which can be larger or smaller, is rotated. Further, since it is not necessary to provide additional components such as a plate spring (urging member) and the like for urging the chassis mount, a manufacturing cost can be reduced and the apparatus can be made compact by suppressing an increase of the number of components. Since the sliding load on the chassis mount can be minimized in the area from the lowered position to just in front of the raised position, the chassis mount can be smoothly moved. Further, since a shock is unlike to act on the press projection, it is sufficient for the press projection to have an elastic force necessary to suppress vibration. Accordingly, the press member can be made compact, the operating load applied to the chassis mount by the elastic force of the press member can be reduced, and a power- and space-saving apparatus can be provided.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

The materials for forming the respective components, the shapes of the components, and the like, for example, are not limited to those described in the embodiment and can be changed when necessary. Although the guide boss and the press projection are formed to the chassis mount integrally therewith and the guide groove and the guide rib are formed to the front wall of the main frame 11 in the embodiment described above, the present invention is not limited thereto.

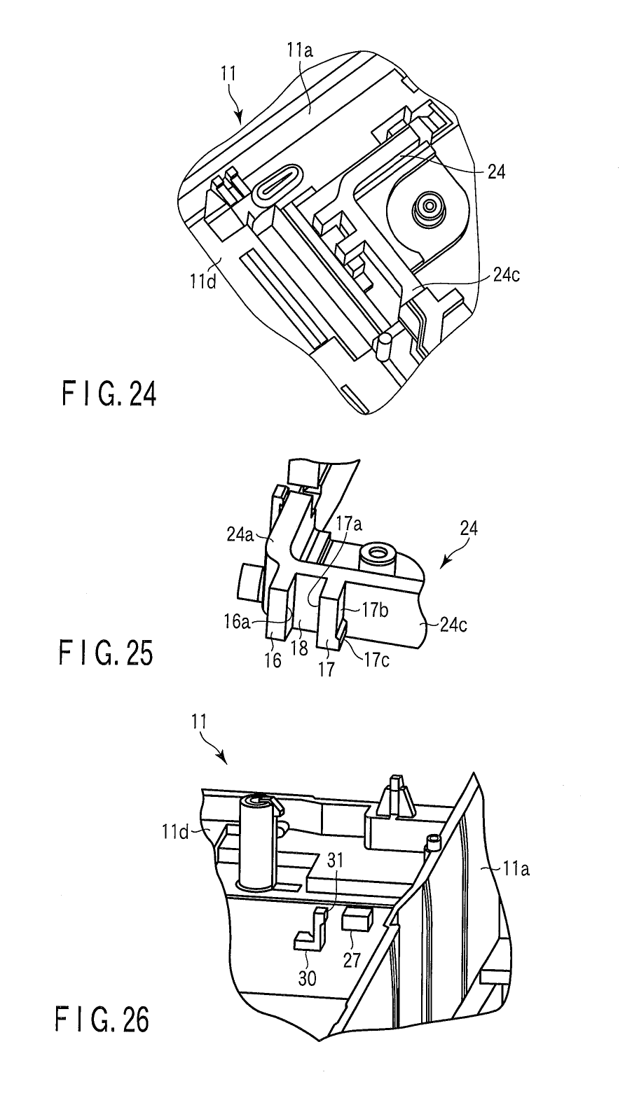

As shown FIGS. 24, 25, and 26, according to an optical disc apparatus of another embodiment of the invention, a guide boss 27 and a press projection 30 for suppressing the vibration of a chassis mount are formed to the inner surface of a front wall 11d of a main frame 11 integrally with the frame. Further, a guide groove 18, which is engaged with a guide boss 27, and a guide rib 17, which has a guide surface 17b engaged with a press projection 30, are formed on a connecting portion 24c side of a chassis mount 24.

In another embodiment, the other arrangement is the same as that of the embodiment described above, and the same components are denoted by the same reference numbers and the detailed explanation thereof is omitted. The same operation/working effect as that the embodiment described above can be obtained also in the another embodiment.

What is claimed is:

1. An optical disc apparatus comprising:
a main frame having a pair of opposing sidewalls and a front wall extending between the sidewalls;
a medium drive unit including a motor which is configured to support and rotate the recording medium and a head unit configured to process information on the recording medium, and arranged for ascent and descent between a drive position in which the recording medium is driven and a retracted position in which the recording medium is allowed to be loaded and unloaded; and
an ascent/descent retaining member which supports the medium drive unit and is supported by the main frame for ascent and descent between a raised position corresponding to the drive position and a lowered position corresponding to the retracted position;
the ascent/descent retaining member including a pair of arm portions extending opposite the sidewalls, individually, a connecting portion extending between one ends of the arm portions and opposing the front wall, and pivotal portions arranged on the respective other end portions of the arm portions and supported on the sidewalls, individually,
one of the front wall of the main frame and the connecting portion of the ascent/descent retaining member integrally having a guide boss projecting toward the other of them and a press projection which is provided adjacent to the guide boss and formed to be elastically deformable in a direction in which the connecting portion extends, and
the other of the front wall and the connecting portion having a guide groove which extends in the ascent and descent direction and is engaged with the guide boss, and a guide rib which has a guide surface for deforming the press projection to generate an elastic force and is provided adjacent to the guide groove.

2. The optical disc apparatus according to claim 1, wherein the guide boss and the press projection are arranged at an interval in the direction in which the connecting portion extends.

3. The optical disc apparatus according to claim 1, wherein the guide boss and the press projection are provided at the connecting portion of the ascent/descent retaining member, and the guide groove and guide rib are provided at the front wall.

4. The optical disc apparatus according to claim 1, wherein the guide boss and the press projection are provided at the front wall, and the guide groove and the guide rib are provided at the connecting portion of the ascent/descent retaining member.

5. The optical disc apparatus according to claim 1, wherein the guide groove is formed to have a width which is gradually narrowed from the lowered position of the ascent/descent retaining member toward the raised position thereof, and the guide boss moves in the guide groove with a gap while the ascent/descent retaining member moves between the lowered position and just in front of the raised position, and the guide boss is formed to have a size that it has a gap to a wall surface defining the guide groove when the ascent/descent retaining member moves to the raised position.

6. The optical disc apparatus according to claim 1, wherein the press projection has an abutting portion, and the guide surface of the guide rib has an elastic abutting portion which deforms the press projection by abutting the abutting portion of the press projection when the ascent/descent retaining member moves to the raised position.

7. The optical disc apparatus according to claim 1, which further comprises: a recording medium holding member which is configured to hold the disc recording medium and is arranged on the main frame for movement between a loading/unloading position in which the holding member projects out of the main frame and an operating position in which the recording medium is configured to be driven in a predetermined position in the main frame; and
a movement mechanism which moves the ascent/descent retaining member to the retracted position while the recording medium holding member is moving and moves the ascent/descent retaining member and the medium drive unit to the driving position when the recording medium holding member is moved to the operating position.

8. The optical disc apparatus according to claim 7, wherein the movement mechanism includes a sliding member which engages with the ascent/descent retaining member, is arranged on the front wall to be movable in a direction across the sidewalls, and moves to raise and lower the ascent/descent retaining member; and a drive source configured to move the sliding member.
